(19) United States
(12) Patent Application Publication
(10) Pub. No.: US 2016/0098701 A1
(43) Pub. Date: Apr. 7, 2016

(54) METHOD AND APPARATUS FOR TRANSACTION MANAGEMENT

(71) Applicant: Cooper HARRIS, Venice, CA (US)

(72) Inventor: Cooper HARRIS, Venice, CA (US)

(21) Appl. No.: 14/873,155

(22) Filed: Oct. 1, 2015

Related U.S. Application Data
(60) Provisional application No. 62/058,553, filed on Oct. 1, 2014.

(51) Int. Cl. G06Q 20/32; G06Q 50/00; G06Q 30/02

(52) U.S. Cl. CPC G06Q 20/3223; G06Q 30/0267; G06Q 30/0273; G06Q 50/01

(57) ABSTRACT

The system provides a method and apparatus for initiating and completing a financial transaction from within an app, application, interface, email, ad, or the like, including social media apps, with very few steps. The system is agnostic as to merchant or advertiser, and allows a user to establish a single account that can be used for quick purchases across multiple platforms and promotional streams. The system is not limited to mobile devices but may be used in any computing environment. In a case of first time use, the system streamlines the account creation process by scraping required account data of the user from available sources. Any missing information may be requested at the time of account creation, or, if not immediately required, may be deferred to a later time. Subsequent interactions and purchases will be accomplished within the app and can be done in just a few clicks.

This patent application claims priority to U.S. Provisional Patent Application No. 62/058,553 filed on Oct. 1, 2014, which is incorporated by reference herein, in its entirety.

### BACKGROUND OF THE SYSTEM

The use of mobile computing devices as a supplement to, or replacement for, desktop computing systems has increased dramatically. Users of such devices expect to be able to use them to enhance all aspects of their lives, including socializing, communicating, information collecting, and performing all manner of financial transactions.

The functionality of many social networks, applications, ads, and interfaces has been limited by the inability to allow a user to easily initiate and complete a financial transaction. In particular in a mobile environment, completing a financial transaction can be a tedious process. Many companies are using social network apps such as Twitter, for example, to send advertisements and offers to users. If a user desires to purchase an advertised product, the user typically is redirected from the app or environment in which the user is operating. For example, if a user is in Twitter, the user will be redirected to Twitter's in-app browser where they browse to the web site of the merchant/advertiser, and go through a number of steps before completing a financial transaction for a product that was advertised on the social media app. In Instagram, for example, the user is redirected from Instagram to a separate browser (e.g. Safari) and from there browses to the site of the merchant/advertiser. After the transaction, the user must manually return to the app or social media that had been in use. A similar process is required when users encounter similar offers even via ads presented to them during their social media, in-app, e-mail, or browsing experience. Studies have shown that it can take ten or more clicks or page transitions to complete a financial transaction, particularly where the user does not have a pre-existing account with the merchant of the goods or services to be purchased.

Even if the user has an account at one or more merchants, the user may want to execute a financial transaction with a new merchant periodically. In some cases, the user may not desire to have accounts at multiple merchants and may therefore be reluctant to initiate a financial transaction due to the complexity, risk, and time required to do so.

### SUMMARY

The system provides a method and apparatus for initiating and completing a financial transaction within an app (including social media apps), application, ad, interface, dialog box, pop-up, message, e-mail, third party websites, and the like. The system is agnostic as to merchant or advertiser, and allows a user to establish a single account that can be used for quick purchases in a mobile or other computing environment, including desktop, laptop, tablet based, gesture based, watch based, eyeglass based, and the like. The system is not limited to mobile devices but may be used in any computing environment. In a case of first time use, the system streamlines the account creation process by scraping required account data if available (e.g. from social media APIs, device data, and the like) from the app at which the first transaction is initiated, or by providing the option of allowing the user to choose another source of the data, such as Facebook, Twitter, Instagram, Google+ or the like. Any missing information may be requested at the time of account creation, or, if not immediately required, may be deferred to a later time. Subsequent interactions and purchases will be accomplished within the present system and can be done in just a few clicks. The system also provides a streamlined payment process to a user whenever a new or registered user is presented with an offer using the system. In particular, the payment system may be used within ads provided by third parties without the need for the third party to have their own payment system. The system may also provide time delimited payment ability so that offers may be time-based. The system is operating system independent and can operate on any environment or device.

### BRIEF DESCRIPTION OF THE DRAWINGS

FIG. 1 is a flow diagram illustrating the operation of the system interacting with a new user in one embodiment.

FIG. 2 illustrates an example of a payment process for a registered user.

FIG. 3 is an example of the user interface in an embodiment of the system.

FIG. 4 is a block diagram illustrating the relationship of the system with vendors, social media apps, or other offer platform, and users.

FIG. 5 is a flow diagram illustrating the creation of an offer in an embodiment of the system.

FIG. 6 is illustrates an embodiment of the system.

FIG. 7 illustrates an example computer environment of the system.

### DETAILED DESCRIPTION OF THE SYSTEM

The system provides a method and apparatus for initiating and completing a financial transaction from within any app, including social media apps. The system provides a call-to action (usually a link, but could be a graphical symbol, such as a button or some other call-to-action that provides a unique URL that permits one touch buy ability) to social platforms, ads, SMS, e-mails, sites, blogs, and the like. This call-to-action, when clicked, displays an icon or button (or other simple form of call-to-action) from within an app that can be used to initiate and complete a financial or other transaction (even if the transaction cannot be completed in-app, the system significantly reduces transaction steps and registration procedures). The system first determines if the person attempting the transaction is a registered user of the system. If not, the system initiates a streamlined registration process designed to register the user in as few steps as possible. In subsequent transactions, the registered user will be able to initiate and complete financial transactions from within any app with very little effort.

The system provides a way for a merchant, advertiser, or offering entity to place an icon, button, link, or some other call-to-action on a website, in an app, in an ad, in a social media feed, in an e-mail, in an application, or in any other platform or environment. The call-to-action is allows a user to complete an action, for example, a financial transaction, by activating the call-to-action. The call-to-action of the system is independent of the offer being presented. The call-to-action of the system allows the financial or other participation to be accomplished through the system without the need for the offering entity to provide its own clearinghouse, financial processing system, or payment processing system. Similarly, the user need not be enrolled or registered on a plurality of web sites, platforms, or payment systems to participate in the system.

Offering Entity

The offering entity may be a merchant, advertiser, individual, charity, or any other entity (e.g. “offering entity”) that desires to present an offer to a user. The offer may be in the form of an advertisement or other opportunity and may be presented in one or more platforms, operating systems, apps, e-mails, social media feeds, texts, SMS messages, applications, and the like. The offering entity can create an offer and access the system to provide a call-to-action that is embedded or provided on the desired platform and associated with the offer.

FIG. 5 is a flow diagram illustrating the creation of an offer by an offering entity in an embodiment of the system. At step 501 an offering entity creates an offer to be delivered in a platform. The offering entity does not need to have its own payment processing system. This allows the offering entity to be, for example, a small business, an infrequent offering entity, a charity, or an individual. For an individual, there is no need to necessarily use a selling site such as ebay or craigslist, the individual can present an offer in their social media feed and attach/embed a call-to-action from the system that allows a buyer to purchase the offered goods or services. The offering entity defines the price and other parameters associated with the offer and those variables are embedded in the script of the call-to-action.

At step 502 the offering entity determines the timing parameters of the offer, if any. Using the system dashboard, an offering entity is able to define a start time and end time of the offer, allowing the offering entity to easily create flash sales and offers associated with and using the system. The start time could be established and the end time could be set or left open-ended as desired. In one embodiment the system allows for recurrence settings to be determined so that the offer can be presented at certain times every day, week, month, or the like.

At step 503 the offering entity determines which platforms will receive the offer. This can be one or more of social media feeds, apps, applications, e-mails, blogs, ads, web sites, and the like. At step 504 the offering entity may optionally determine the recipients that will receive the offer. For example, if an offering entity is presenting the offer in a social media feed, the offering entity may define a subset of “friends” to receive the offer, make it public, or private, or define a list of users that can see and/or interact with the offer. In one embodiment, the system can take advantage of filters on the platform to define recipients.

At step 505 the system receives the offer and parameters and posts the offer directly to the correct social media or other promotional feed(s) or schedules the offer for delivery at the correct time to the correct social media or other promotional feed(s). If scheduled at a later time, at step 506 the system delivers the offer.

In one embodiment, the system allows the offering entity to create links to its inventory system so that a count of available SKUs can be provided to users. In addition, size information, shipping methods, and other information can be linked to the call-to-action to enhance the user experience.

In one embodiment, the system allows the offering entity to include a link to other offers (e.g. a gallery link) that are available from the offering entity. In one embodiment, the link redirects the user to a site with multiple available offers from the offering entity.

In operation, the call-to-action of the system is provided in one embodiment as an Inline Frame (IFrame) which is an HTML, document that is embedded inside another HTMl XML, Ajax, and the like document. An advantage of the IFrame is that the designer of the IFrame can control the IFrame's content independently of the domain in which the IFrame is displayed. Additionally, a user interacting within an iFrame can initiate the call-to-action without navigating away from or reloading/refreshing the surrounding page. This allows the call-to-action of the system to operate independently of the surrounding platform and provides a true in-app experience for the user. The IFrame can be loaded with scripts to control the timing of the call-to-action as described above, as well as with the necessary scripts to provide the transaction desired by the user. In one embodiment, the system provides a number of unique calls-to-action that can be accessed by the offering entity and provided with an offer, where each type of call-to-action has its own associated script. Alternatively, the call-to-action may also be displayed in any number of static ads or rich media ads, allowing a similar experience.

In one embodiment, the offering entity can define an IFrame that describes the offer and the system provides an API that allows the offering entity to embed a URL in the IFrame linking to the system call-to-action icon.

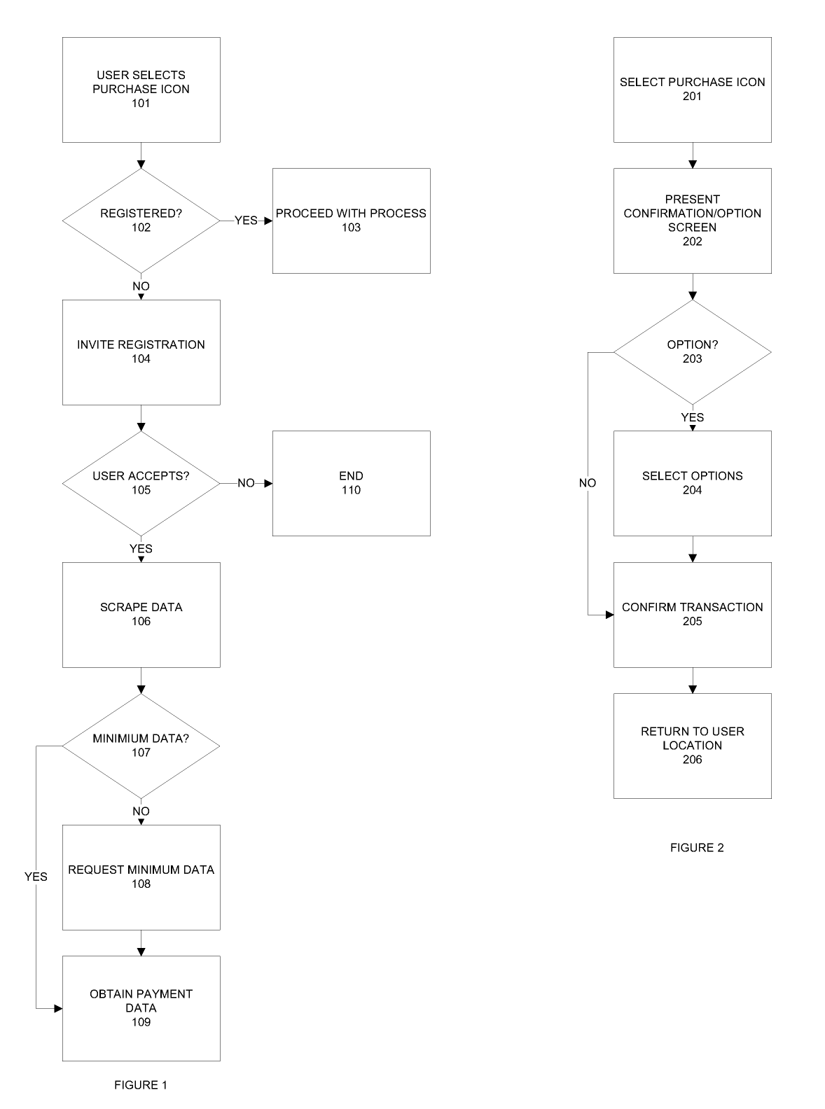

The system can be used to accept donations for a charity or a political transaction. Typically, because such transactions do not require the shipment or delivery of goods or services in return, the operation of such a call-to-action is different than a call-to-action for a typical purchase transaction. The charity can insert a request for donation in a social media stream or other promotional vehicle such as SMS, email or ad and a user can donate by selecting the system icon. If the user is not registered, the set up process of FIG. 1 below is initiated prior to accepting the donation (In some cases, certain restrictions and confirmations are required by law surrounding political contributions, in such a case, the system will prompt users to confirm or input the required information). Subsequently, the user will be able to donate using the system of FIG. 2 below. In one embodiment, the system allows an adjustable call to action where the amount of the donation may be adjusted by the user (e.g. from a minimum suggested donation to a higher donation) such as by a slider, arrow controls, direct entry, and the like.

The system can also be used for non-financial transactions and to handle any type of call-to-action. For example, the system may be used to accept entry into a sweepstakes or other contest. The system may be used for voting in a poll, election, survey, opt-in to a subscriber list, and the like. The call-to-action itself may be framed as a game or entertainment that is easily inserted into a desired platform. The system may be used in any of a number of scenarios that would necessitate a users' confirmation plus their input of identifying information wherein the user saves time and effort by confirming their intent with considerably fewer steps and without the need to repetitively fill out their identifying information. This might be registering for an event, signing an online petition, or even verifying/executing an online document. The system might also be used to generate customized leads for different offering entities.

User Experience

A user may encounter the call-to-action in one or more of the platforms described above. If the user wishes to respond to the offer or call-to-action, the user need simply click or activate the call-to-action and the system performs the steps necessary to complete the offer. The user can interact with the call-to-action as a new user or as a registered user.

FIG. 1 is a flow diagram illustrating the operation of the system interacting with a new user in one embodiment. Consider a situation where a user is in a social media app or some other platform and encounters an offer of a product or service for sale. The social media app utilizes the present system and there is an icon or button that is used to enable the purchase of the goods or service by the user from within the app (or to perform some other call-to-action).

At step 101 the user of the social media app selects the purchase icon. At decision block 102 the system determines if the user is a registered user. If so, the system proceeds to step 103 and continues with the purchase steps (See FIG. 2). In one embodiment, the system may determine the user's identity (based on third party OAuth, for example). The system determines whether or not the user is a registered user by checking third party, open-source, and/or publically accessed platforms (e.g. social media) that allow the system to confirm the user identity via a token from such a platform, without the user needing to provide the information. This identification is agnostic to the underlying app, platform, or operating system in use, but is independent, allowing it to be invoked in any desirable situation.

If the user is not registered at decision block 102 the system proceeds to invite the user to register at step 104. At decision block 105 it is determined if the user accepts the offer to register. If not, the process ends at step 110 and the user is returned to their prior page or location in the social media app. In one embodiment, the user remains at their location as the call-to-action is part of an IFrame that can execute the steps within the frame as desired. If the user accepts, the system proceeds to step 106 and scrapes user information from the user's social media app account (e.g. OAuth) or any other available sources. The system uses that information to identify the user and, in most cases, to populate the registration fields of the system. In some cases, the system may ask if the user wants to permit the system to use the user information from some other user account, such as Facebook, Twitter, Instagram, or the like, to complete the information needed for the registration process.

At decision block 107 the system determines if it has the minimum data required to register the user to the system. At this point, even though more information might be desired from the user, the system can defer the collection of that information for sake of expediency. In one embodiment, the minimum information required is that information that can be used to validate a credit transaction and to deliver the product to the user (e.g. name, credit card or other payment information, and delivery address, physical or digital). If the goods comprise a coupon or other digital product, an email address may be sufficient at this stage. In other embodiments, the digital product may be provided via link to the social media account, obviating even the need for an email address. If the goods are physical, a mailing or delivery address is required. If the goods are a sweepstakes, an email address may be sufficient, until a winner has been identified. In the case of political donations, affirmation of US citizenship is required, and is stored, in addition to email. At this point, decision block 107 is determining if the minimum non-credit information is satisfied, assuming that the system is unable to scrape credit card or other payment method information (e.g. BitCoin, PayPal, digital wallet, iPhone touch payments, and the like) from the user account data on the social media app or from some other appropriate API which would deliver that information. In one embodiment the system allows the user to provide credit card information by scanning the user's credit card using a camera or scanning device associated with the processing system (e.g. mobile phone, laptop, tablet, etc,) that is being used.

If the automatic scraping has not provided the minimum data required, the system requests it at step 108. After step 108, or if the minimum data was available at step 107, the system obtains payment information from the user at step 109 (if payment information was otherwise not obtained in prior steps). At this point the user is considered registered and the transaction can be completed at step 103. At some future time, the system may prompt the user to complete any additional desired account and registration information.

In one embodiment, the user registration may include preferred sizes of different types of clothing (e.g. shoe size, dress size, pant size, shirt size, and the like) so that there is no need to enter size information when purchasing clothing items. The system also permits the user to define shipping preferences (e.g. overnight, two-day, standard, and the like).

FIG. 2 illustrates an example of a payment process for a registered user. At step 201 the user is on a site (for purposes of example, a social media site) and is presented with an offer. This offer may be a tweet, a Facebook posting, a pop-up ad, email, call-to-action on a website, and the like. The offer includes a call to action that may be represented as a system icon, a systemized area of the screen, a systemized image (e.g. any image such that interaction with the image in a desired manner triggers the purchase activity) that is used to complete the purchase or selection of the offer. The user clicks, activates, or triggers the call to action at step 201. At step 202, the system presents the user with a confirmation screen that allows the user to simply confirm the transaction and also, in one embodiment, presents the user an icon to modify purchase options. This may all take place within an IFrame in the app or platform so that the user is not redirected from the original site.

At decision block 203 it is determined if the user has selected the options icon at step 202. If so, the system proceeds to step 204 and the user selects the desired options. These options may include the choice of payment method (e.g. selecting one of a plurality of credit cards or online payment systems), billing address, delivery address, and/or shipping options (e.g. overnight, ground delivery, and the like). This optional step may take place at any other part of the process flow. At any time while viewing the offering, the user may opt to change their billing info, shipping address, and make changes to personal information stored within their profile by clicking on their profile picture or icon displayed for this purpose.

After step 204, or if the user has not selected options at step 203, the system proceeds to step 205 where the user confirms the transaction by clicking an icon. At step 206, the user is returned to a page confirming the user's purchase or action, often with a “Thank You” and the ability to ‘share’ or post their actions on social media. In one embodiment, after the transaction has been confirmed, the user is offered a chance to move to the merchant's web site to continue shopping. In another embodiment, the user is presented another similar product or action to take (referral engine).

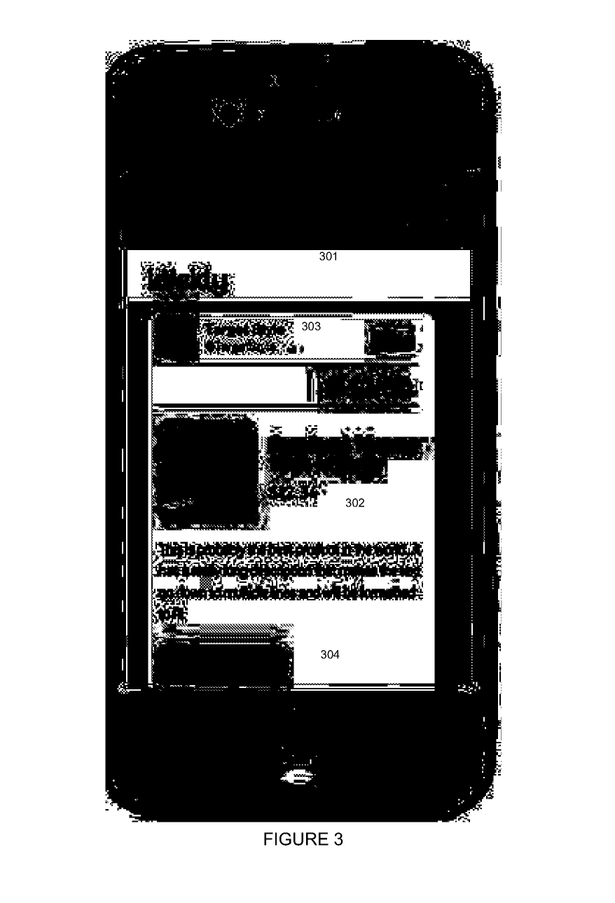

FIG. 3 is an example of the user interface in an embodiment of the system. A mobile device such as smart-phone 300 is used to access a social media app such as Twitter 301. A tweet is presented to the user and includes an offer 302 to purchase a product from an offering entity 303. Also provided is the in-app purchase icon 304 that allows the user to purchase the offered product. In some cases the offer may have a time limit and in such cases, a clock, countdown feature, or the like may be presented to the user (see FIG. 3). Although shown as an icon 304, the system contemplates a call to action in any one of a number of suitable forms, such as sliders, direct entry, activated display regions, activated images, and the like.

After a successful user transaction, the user is provided confirmation of the transaction. In one embodiment, the system can provide another offer or action using a referral engine. The referral engine uses user history, demographic information, and offering entity information to choose an optimized follow up offer or action for the user.

System

The system is independent of the offering entity and the user who responds to the call-to-action, providing an ability for parties to invoke and use transaction systems without the need to build their own.

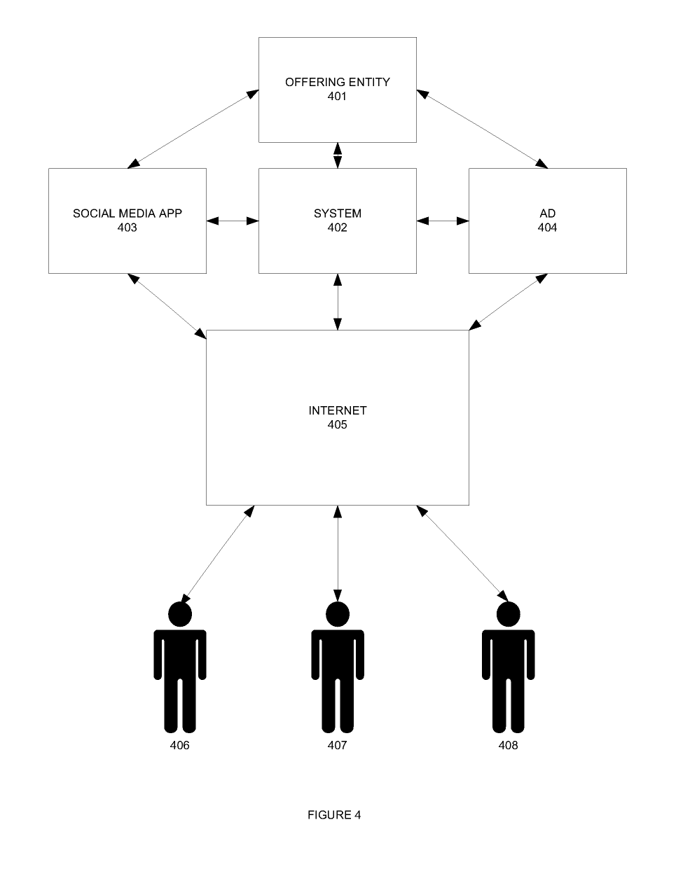

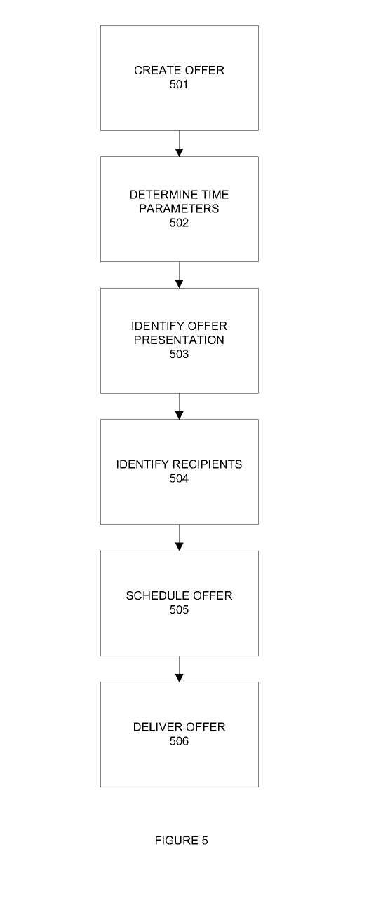

FIG. 4 is a block diagram illustrating an embodiment of the relationship of the system with offering entities, social media apps, and users. The system 402 can receive proposed offers from an offering entity 401. The offers are intended to be provided as tweets or posts in social media apps (and also in other promotional vehicles such as pop-up ads and emails); for examples of such as social media app 403 or Ad 404. Although FIG. 4 illustrates a social media app 403 and Ad 404, the system has equal application to any environment in which it would be advantageous to insert the ability to complete a financial transaction, including e-mail, web sites, blogs, posts, and the like. The system 402 provides the infrastructure for assembling the post and delivering it to the social media app 403 or Ad 404 at a scheduled time and to one or more selected users 406, 407, or 408. A user 406, 407, and/or 408 interacts with a social media app 403, Ad 404 via the Internet 405 or some other suitable network environment. If the user determines to purchase the offered product or service, payment is handled through the system 402 and fulfilment is handled by the merchant 401.

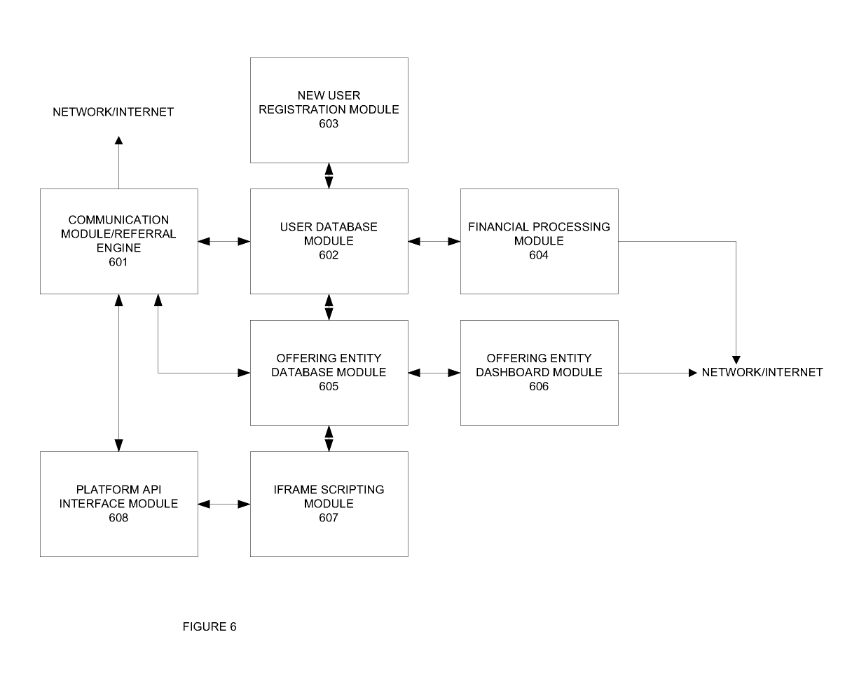

FIG. 6 illustrates an embodiment of the system 402. The system communicates with a network (e.g. the Internet) via a communication module/referral engine module 601. The communication module 601 can access the user database module 602 and the offering entity database module 605. The user database module stores registered users of the system and is also used to identify whether an attempted use is from a registered user or from a new user. If a new user, the user database module 602 communicates with the new user registration module 603 to enable registration of the new user. The user database module can also store the financial and address information of the user, along with passwords and other needed information.

The financial processing module 604 is coupled to the user database module 602 and also to the network. The financial processing module is used to process any initiated financial transactions by communicating with the appropriate financial institution (e.g. bank, credit card company, debit card company, and the like) to enable payment for the offer selected by a user.

The offering entity database module 605 is used to retrieve data associated with the call-to-action invoked by a user so that the appropriate amount of the offer can be determined and applied to the transaction, as well as invoking any shipping/delivery of merchandise or services associated with the offer. The offering entity module 605 is in communication with an offering entity via offering entity dashboard module 606, also in communication with the network/Internet. The offering entity may use the dashboard module to add a link to the call-to-action icon of the system in an offer (e.g. IFrame or the like) that is created by the offering entity.

When an offering entity generates an offer via the offering entity dashboard module, the system uses the IFrame scripting module 607 to generate an appropriate call-to-action icon that can be added to the appropriate platform. This IFrame is provided to the platform API interface module 608 that can customize the icon for the appropriate platform before sending it to the platform via communication module 601.

The communication module/referral engine 601 can process and provide communication between the system and users, offering entities, financial institutions, and platforms. This module can also provide the referrals and additional offers to the user based on user history, offer history, offering entity data, and the like.

Embodiment of Computer Execution Environment (Hardware)

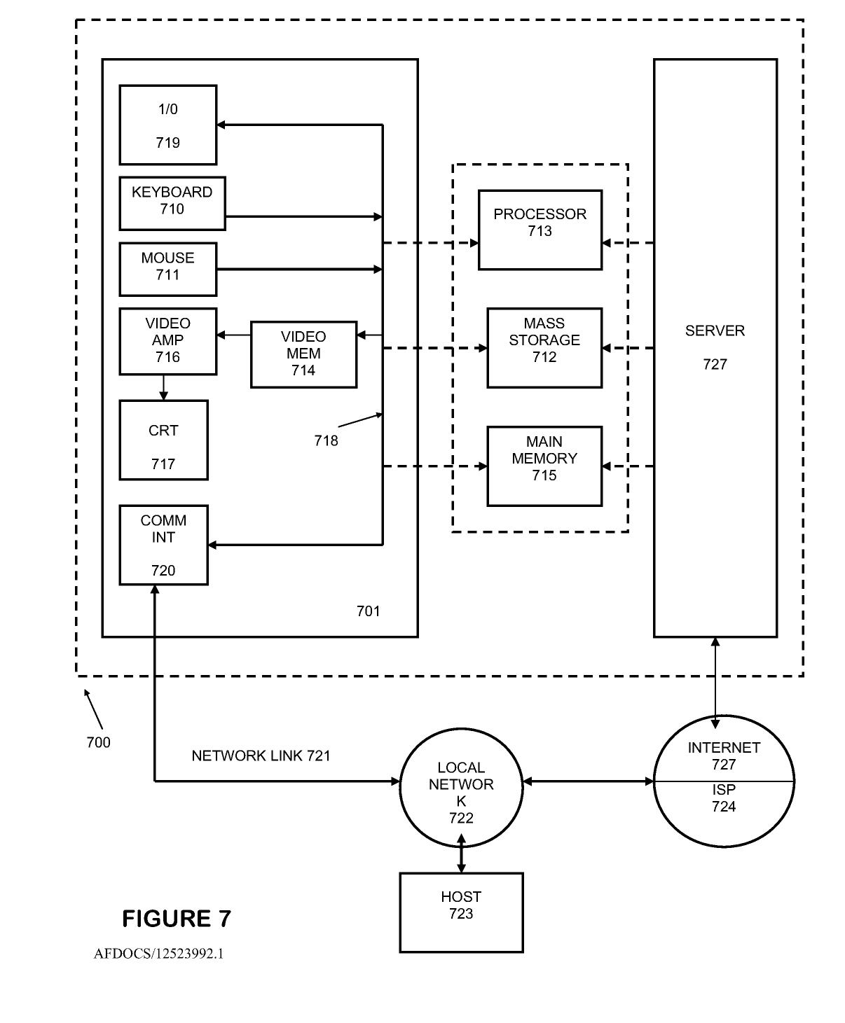

An embodiment of the system can be implemented as computer software in the form of computer readable program code executed in a general purpose computing environment such as environment 700 illustrated in FIG. 7, or in the form of bytecode class files executable within a Java.™ run time environment running in such an environment, or in the form of bytecodes running on a processor (or devices enabled to process bytecodes) existing in a distributed environment (e.g., one or more processors on a network). A keyboard 710 and mouse 711 are coupled to a system bus 718. The keyboard and mouse are for introducing user input to the computer system and communicating that user input to central processing unit (CPU 713. Other suitable input devices may be used in addition to, or in place of, the mouse 711 and keyboard 710. I/O (input/output) unit 719 coupled to bi-directional system bus 718 represents such I/O elements as a printer, A/V (audio/video) I/O, etc.

Computer 701 may be a laptop, desktop, tablet, smart-phone, or other processing device and may include a communication interface 720 coupled to bus 718. Communication interface 720 provides a two-way data communication coupling via a network link 721 to a local network 722. For example, if communication interface 720 is an integrated services digital network (ISDN) card or a modem, communication interface 720 provides a data communication connection to the corresponding type of telephone line, which comprises part of network link 721. If communication interface 720 is a local area network (LAN) card, communication interface 720 provides a data communication connection via network link 721 to a compatible LAN. Wireless links are also possible. In any such implementation, communication interface 720 sends and receives electrical, electromagnetic or optical signals which carry digital data streams representing various types of information.

Network link 721 typically provides data communication through one or more networks to other data devices. For example, network link 721 may provide a connection through local network 722 to local server computer 723 or to data equipment operated by ISP 724. ISP 724 in turn provides data communication services through the world wide packet data communication network now commonly referred to as the “Internet” 727 Local network 722 and Internet 727 both use electrical, electromagnetic or optical signals which carry digital data streams. The signals through the various networks and the signals on network link 721 and through communication interface 720, which carry the digital data to and from computer 700, are exemplary forms of carrier waves transporting the information.

Processor 713 may reside wholly on client computer 701 or wholly on server 727 or processor 713 may have its computational power distributed between computer 701 and server 727. Server 727 symbolically is represented in FIG. 7 as one unit, but server 727 can also be distributed between multiple “tiers”. In one embodiment, server 727 comprises a middle and back tier where application logic executes in the middle tier and persistent data is obtained in the back tier. In the case where processor 713 resides wholly on server 727, the results of the computations performed by processor 713 are transmitted to computer 701 via Internet 727, Internet Service Provider (ISP) 724, local network 722 and communication interface 720. In this way, computer 701 is able to display the results of the computation to a user in the form of output.

Computer 701 includes a video memory 714, main memory 715 and mass storage 712, all coupled to bi-directional system bus 718 along with keyboard 710, mouse 711 and processor 713.

As with processor 713, in various computing environments, main memory 715 and mass storage 712, can reside wholly on server 727 or computer 701, or they may be distributed between the two. Examples of systems where processor 713, main memory 715, and mass storage 712 are distributed between computer 701 and server 727 include thin-client computing architectures and other personal digital assistants, Internet ready cellular phones and other Internet computing devices, and in platform independent computing environments,

The mass storage 712 may include both fixed and removable media, such as magnetic, optical or magnetic optical storage systems or any other available mass storage technology. The mass storage may be implemented as a RAID array or any other suitable storage means. Bus 718 may contain, for example, thirty-two address lines for addressing video memory 714 or main memory 715. The system bus 718 also includes, for example, a 32-bit data bus for transferring data between and among the components, such as processor 713, main memory 715, video memory 714 and mass storage 712. Alternatively, multiplex data/address lines may be used instead of separate data and address lines.

In one embodiment of the invention, the processor 713 is a microprocessor such as manufactured by Intel, AMD, Sun, etc. However, any other suitable microprocessor or microcomputer may be utilized, including a cloud computing solution. Main memory 715 is comprised of dynamic random access memory (DRAM). Video memory 714 is a dual-ported video random access memory. One port of the video memory 714 is coupled to video amplifier 719. The video amplifier 719 is used to drive the cathode ray tube (CRT) raster monitor 717. Video amplifier 719 is well known in the art and may be implemented by any suitable apparatus. This circuitry converts pixel data stored in video memory 714 to a raster signal suitable for use by monitor 717. Monitor 717 is a type of monitor suitable for displaying graphic images.

Computer 701 can send messages and receive data, including program code, through the network(s), network link 721, and communication interface 720. In the Internet example, remote server computer 727 might transmit a requested code for an application program through Internet 727, ISP 724, local network 722 and communication interface 720. The received code maybe executed by processor 713 as it is received, and/or stored in mass storage 712, or other non-volatile storage for later execution. The storage may be local or cloud storage. In this manner, computer 700 may obtain application code in the form of a carrier wave. Alternatively, remote server computer 727 may execute applications using processor 713, and utilize mass storage 712, and/or video memory 715. The results of the execution at server 727 are then transmitted through Internet 727, ISP 724, local network 722 and communication interface 720. In this example, computer 701 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

Thus, a method and apparatus for streamlined financial transactions has been described.

What is claimed is:

1. A method of performing a financial transaction comprising:
creating a call-to-action icon to enable a financial transaction;
associating the call-to-action icon with an offer by an offering entity;
receiving an indication that the call-to-action has been selected;
performing the financial transaction enabled by the call-to-action icon;
confirming the completion of the financial transaction.

2. The method of claim 1 wherein the call to action is implemented in an IFrame.

3. The method of claim 1 wherein the call-to-action is associated with a social media account.

4. The method of claim 1 wherein the call-to-action is associated with an ad.

5. The method of claim 1 wherein the call-to-action is associated with an app and is an in-app operation.

6. The method of claim 1 wherein the call-to-action is associated with an e-mail.

7. The method of claim 1 wherein the call-to-action has defined start and end times.

8. The method of claim 1 wherein the call-to-action is associated with an offer created by an offering entity.

9. The method of claim 1 wherein the call-to-action includes a definition of the recipients of the call-to-action.

10. The method of claim 1 wherein the call-to-action is invoked by an unregistered user and the call-to-action initiates an automatic registration process of the unregistered user.
